(19) United States
(12) Patent Application Publication
(10) Pub. No.: US 2007/0109381 A1
(43) Pub. Date: May 17, 2007

(54) Optical disc recorder with printing device

(75) Inventors: Danny Liao, Hsinchu (TW); Yi Cheng Tsao, Hsinchu (TW); Shih Lin Yeh, Hsinchu (TW); Keng Kok Ang, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/599,445

(22) Filed: Nov. 15, 2006

(30) Foreign Application Priority Data
Nov. 16, 2005 (TW) 094140230

(51) Int. Cl. B41J 2/01

(52) U.S. Cl. 347/101

(57) ABSTRACT

An optical disc recorder includes a printing device disposed between an inner surface of housing and a tray and facing a label side of a loaded optical disc. In one embodiment the printing device includes an inkjet printing assembly; a guide mechanism for guiding the printing assembly to move alternately back and forth along a predetermined path above the label side; and a control circuit for controlling the guide mechanism in cooperation with a movement of the printing assembly for printing color text and/or graphics on the label side without turning over the optical disc while the optical disc is rotating in a data recording operation. In another embodiment a scanning module is provided on an opening of the tray. In a further embodiment the inkjet printing assembly is replaced by a thermal printing assembly.

### BACKGROUND OF THE INVENTION

1. Field of Invention

The present invention relates to optical disc recorders (e.g., CD-R drives, or CD-RW drives) and more particularly to such an optical disc recorder with a printing device adapted to print color text and/or graphics on a label side of an optical disc (e.g., CD or the like) while recording data on a data side thereof.

2. Related Art

CD-type and DVD-type optical discs have been widely employed as means of high-capacity storage media. Conventionally, an optical disc (e.g., CD) has a data side and a label side. A pick up unit of an optical disc recorder (e.g., CD-R drive) is adapted to record data on the data side of CD. The label side is also known as CD cover. Conventionally, a user may write label on the label side by means of a marker.

There are typically two techniques employed in the art as a replacement of the well-known marker in writing label. One involves printing color label by a color printer and adhering the color label on the label side of CD. The other is Light-Scribe technique developed by HP. The Light-Scribe technique involves scribing text and/or graphics on a label side of CD with a laser beam. The laser beam is also adapted to bleach (i.e., burn) small areas of dyed plastic in recording data on the data side of CD. However, only monochromic text or graphics is capable of printing on the label side of CD due to limitation of the dyed plastic material. In other words, only the first technique is available for printing color text and/or graphics. However, auxiliary equipment may be required for adhering correctly a label on the label side of CD. It is known that an uneven label adhered to the label side of CD may adversely affect quality of reading data from the data side of CD or writing data thereon.

There is another drawback associated with the second Light-Scribe technique. In short, after recording data on a data side of CD, it is required to turn over the CD prior to scribing text and/or graphics on a label side thereof. It is very inconvenient.

Thus, it is desirable to provide a novel optical disc recorder capable of printing color text and/or graphics on a label side of an optical disc without turning over the optical disc in order to overcome the inadequacies of the prior art and contribute significantly to the advancement of the art.

### SUMMARY OF THE INVETION

It is therefore an object of the present invention to provide an optical disc recorder capable of printing color text and/or graphics on a label side of an optical disc loaded while recording data on a data side thereof without turning over the optical disc.

To achieve the above and other objects, the present invention provides an optical disc recorder comprising a housing; an optical pick up module; a tray; a spindle motor mounted in a center of the tray; and a printing device disposed between an inner surface of the housing and the tray and facing a label side of a loaded optical disc, the printing device comprising an inkjet printing assembly; a guide mechanism for guiding the printing assembly to move alternately back and forth along a predetermined path above the label side; and a control circuit for controlling the guide mechanism in cooperation with a movement of the printing assembly for printing color text and/or graphics on the label side when the optical disc is rotating in a data recording operation.

In one aspect of the present invention, the printing assembly includes a print head and an ink cartridge.

In another aspect of the present invention, the spindle motor is adapted to intermittently or continuously angularly rotate the optical disc in cooperation with the movement of the printing assembly.

In yet another aspect of the present invention, for refilling the ink cartridge it is possible of filling ink into a plurality of ink apertures thereof through a plurality of holes formed on the housing, configuring the printing assembly as a removable one, or providing a hinged cover on the housing such that opening the cover will enable a user to replace a consumed ink cartridge with a new one.

In a further aspect of the present invention, the printed color text and/or graphics is stored in a computer.

In yet further aspect of the present invention, a scanning module is additionally provided on an opening of the tray such that not only data stored in a data side of a loaded optical disc can be read by the recorder but also contents printed on the label side thereof is scanned by the scanning module when the optical disc is loading into the tray. Thus, both read data and contents of the label side can be recorded on a data side of an empty optical disc and printed on a label side of the same respectively in a next copying operation.

In yet further aspect of the present invention, the inkjet printing assembly is replaced by a thermal printing assembly including a color ribbon module and a heating head for heating a passing ribbon prior to printing color text and/or graphics on the label side of an optical disc.

The above and other objects, features and advantages of the present invention will become apparent from the following detailed description taken with the accompanying drawings.

### BRIEF DESCRIPTION OF THE DRAWINGS

FIG. 1 is a top plan view of a first preferred embodiment of optical disc recorder according to the invention;

FIG. 2 is a view similar to FIG. 1 where a CD is loaded and the drive shaft of spindle motor is turning while data recording and label printing are being performed concurrently;

FIG. 3 is a view similar to FIG. 2 where another configuration of the guide mechanism is illustrated;

FIG. 4 is a top plan view of a second preferred embodiment of optical disc recorder according to the invention; and

FIG. 5 is a schematic elevation view of a third preferred embodiment of optical disc recorder according to the invention.

### DETAILED DESCRIPTION OF THE INVENTION

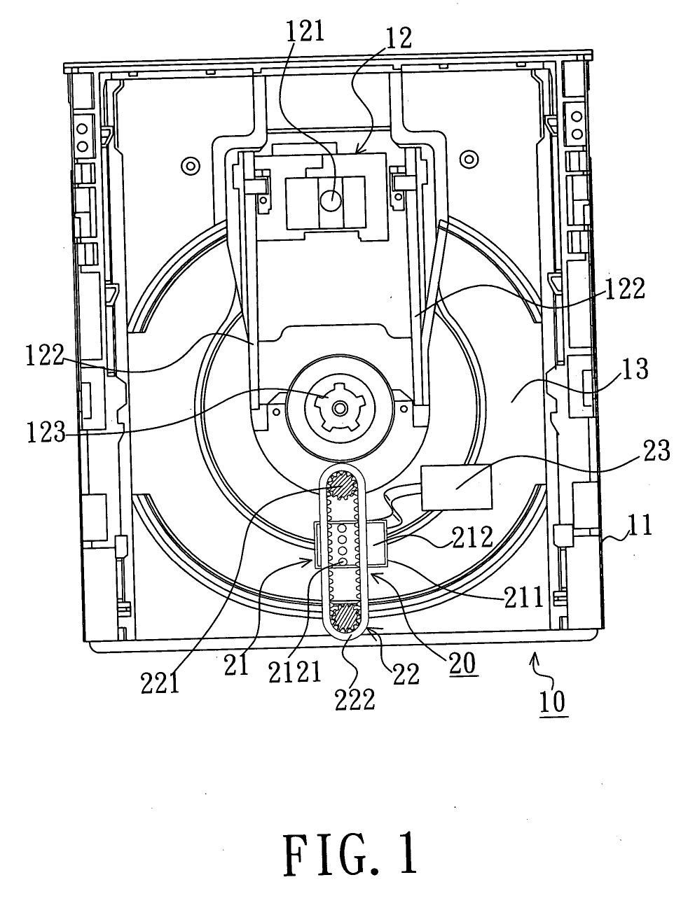

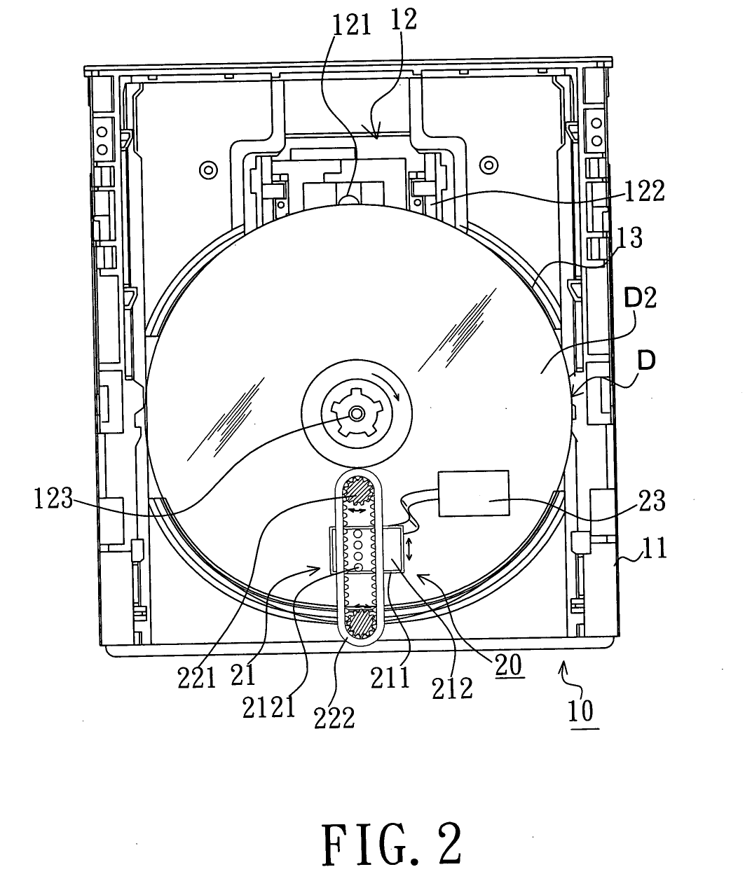

Referring to FIG. 1 and FIG. 2, a first preferred embodiment in accordance with the invention is shown. The embodiment comprises an optical disc recorder 10 and a printing module 20. The recorder 10 comprises a parallelepiped housing 11, an optical pick up module 12, and a tray 13 for loading or unloading an optical disc (e.g., CD) D. The optical pick up module 12 includes a pick up unit 121 for recording data on a data side D1 (not shown) of optical disc D or reading data thereon, a pair of parallel guide rods 122 for guiding the pick up unit 121, and a spindle motor 123 having a drive shaft for rotating the optical disc D.

The printing module 20 is provided between an inner surface of the housing 11 and the tray 13 and faces a label side D2 of optical disc D. The printing module 20 comprises an inkjet printing assembly 21, a guide mechanism 22 for guiding the printing assembly 21, and a control circuit 23 for controlling the guide mechanism 22 and the printing assembly 21. The printing assembly 21 includes a print head 211 and an ink cartridge 212 for supplying ink to the print head 211. The print head 211 is driven by the guide mechanism 22 to move alternately back and forth along a predetermined path above the label side D2. Also, the print head 211 is adapted to shoot tiny droplets of ink at the label side D2 in cooperation with the optical disc D being rotated by the activating spindle motor 123. A plurality of holes (not shown) are formed on the housing 11. For refilling the ink cartridge 212, a user may fill ink into a plurality of ink apertures 2121 thereof through the holes. Ink refilling, however, is not limited to the above as contemplated by the invention. For example, it is possible of configuring the printing module 20 as a removable one in other embodiments. That is, a user may remove the ink cartridge 212 out of the housing 10 for replacement. Alternatively, a hinged cover is formed on the housing 11 such that a user may replace a consumed ink cartridge 212 with a new one by opening the cover. The guide mechanism 22 comprises two gears 221 driven by a motor (not shown) and a belt 222 rotatably put on the gears 221. The belt 222 is operatively connected to the ink cartridge 212 such that the ink cartridge 212 may move alternately back and forth along a predetermined path in response to the rotation of the belt 222. By configuring the recorder 10 as above, after loading an optical disc D it is possible of recording data on the data side D1 of the optical disc D and printing color text and/or graphics on the label side D2 thereof in one operation without turning over the optical disc D.

Referring to FIG. 2, it is shown that an optical disc D is loaded and the drive shaft of the spindle motor 123 is rotating. As illustrated, in one procedure a user may perform operations of inserting the optical disc D into the recorder 10, activating the printing module 20 to print color text and/or graphics stored in a computer on the label side D2 of the optical disc D, and recording data on the data side D1 of the optical disc D. Alternatively, in another procedure a user may perform operations of inserting the optical disc D into the recorder 10, recording data on the data side D1 of the optical disc D, and activating the printing module 20 to print color text and/or graphics stored in a computer on the label side D2 of the optical disc D. The spindle motor 123 may intermittently or continuously angularly rotate the optical disc D for printing desired color text and/or graphics on a portion thereof when the printing assembly 21 is driven by the belt 222 to move alternately back and forth along a predetermined path above the label side D2. As stated above, the printing module 20 corresponds to the label side D2 and is disposed opposite the pick up unit 121. Thus, there is no need of removing the optical disc D and turning over same. In brief, data recording and label printing are performed concurrently in one operation.

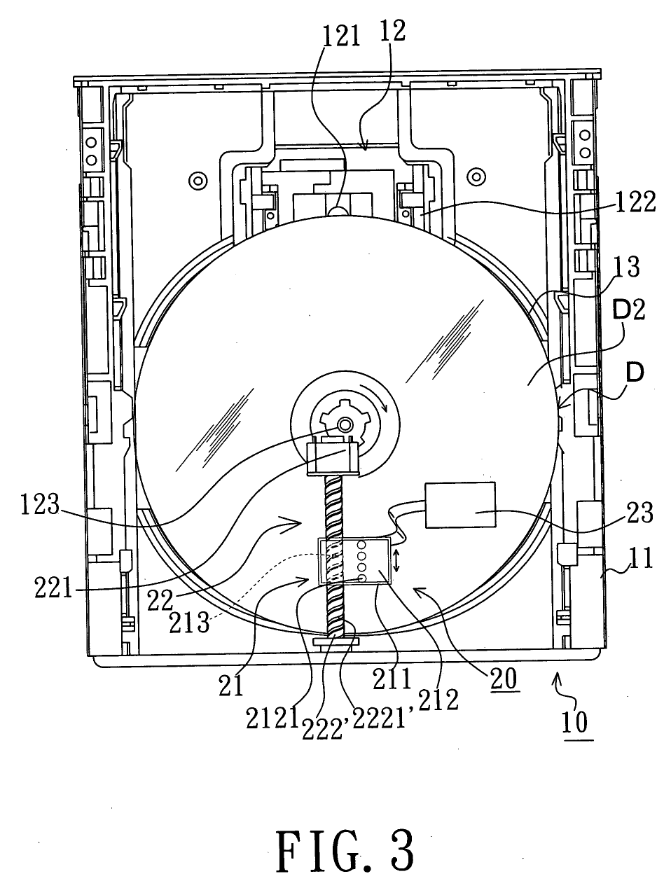

Referring to FIG. 3, another configuration of the guide mechanism 22 is illustrated. The belt 222 is replaced with a shaft 222′ having outer driven threads 2221′ through the printing assembly 21. An internal pin 213 is provided in the printing assembly 21 and is slidably disposed in the threads 2221′. The threads 2221′ may advance as the shaft 222′ rotates in response to rotating the gears 221 driven by its associated motor in operation. The pin 213 thus moves along the threads 2221′. As a result, the printing assembly 21 moves above a corresponding surface of the optical disc D while shooting tiny droplets of ink at the label side D2 in cooperation with the optical disc D being rotated by the activating spindle motor 123.

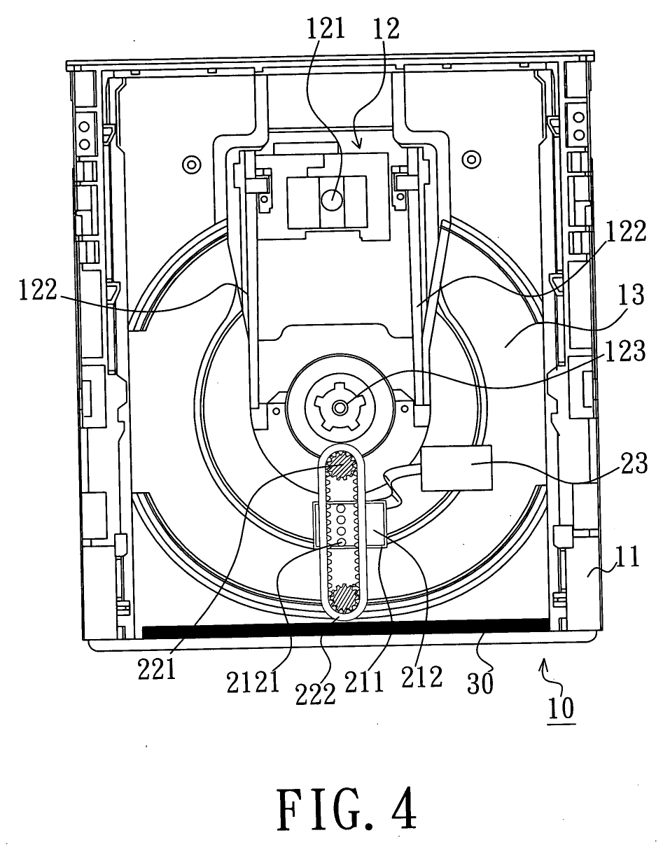

Referring to FIG. 4, a second preferred embodiment in accordance with the invention is shown. The embodiment is characterized by providing an additional scanning module 30 on an opening of the tray 13. Not only data stored in a data side of a loaded optical disc can be read by the recorder 10 but also contents printed on the label side thereof is scanned by the scanning module 30 when the optical disc is loading into the tray 13. Both read data and contents of the label side are then stored in a computer. Thereafter, both read data and contents of the label side can be recorded on a data side of an empty optical disc and printed on a label side of same respectively in a next optical recording (i.e., copying) operation.

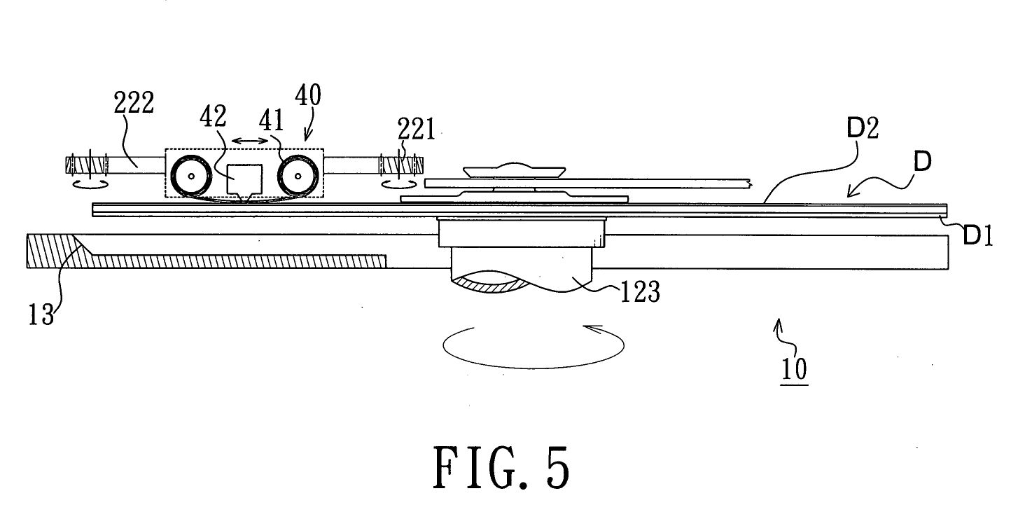

Referring to FIG. 5, a third preferred embodiment in accordance with the invention is shown. The printing assembly 21 is replaced by a high speed thermal printing module 40. The thermal printing module 40 comprises two color ribbon reels 41 and a heating head 42 provided there between. The color ribbon reel 41 comprises either a first ribbon with yellow (Y), magenta (M), and cyan (C) colors and a protective ribbon or a second ribbon with yellow (Y), magenta (M), cyan (C), and black (K) colors. The activating heating head 42 is adapted to heat a portion of the color ribbon reels 41 passing it prior to printing color text and/or graphics on a label side D2 of an optical disc D.

The heating head 42 comprises a plurality of heating elements. The number of the heating elements corresponds to the number of colors contained in the color ribbon reels 41. Preferably, the number of the heating elements is at least four for heating each color component of the color ribbon reels 41. The heating head 42 is adapted to heat at least 256 different shades of gray corresponding to temperature changes. Correspondingly, printed label has at least 256 different levels of color. As a result, more colorful label is obtained as compared with one printed by typical color inkjet printer.

While the invention herein disclosed has been described by means of specific embodiments, numerous modifications and variations could be made thereto by those skilled in the art without departing from the scope and spirit of the invention set forth in the claims.

What is claimed is:

1. An optical disc recorder comprising:
a housing;
an optical pick up module;
a tray;
a spindle motor mounted in a center of the tray; and
a printing device disposed between an inner surface of the housing and the tray and facing a label side of a loaded optical disc, the printing device comprising:
an inkjet printing assembly;
a guide mechanism for guiding the printing assembly to move alternately back and forth along a predetermined path above the label side; and
a control circuit for controlling the guide mechanism in cooperation with a movement of the printing assembly for printing color text and/or graphics on the label side when the optical disc is rotating in a data recording operation.

2. The optical disc recorder of claim 1, wherein the printing assembly includes a print head and an ink cartridge.

3. The optical disc recorder of claim 1, wherein the spindle motor is adapted to intermittently or continuously angularly rotate the optical disc in cooperation with the movement of the printing assembly.

4. The optical disc recorder of claim 1, wherein the guide mechanism comprises a motor, two gears driven by the motor, and a belt rotatably put on the gears, the belt being operatively connected to the printing assembly for its movement.

5. The optical disc recorder of claim 1, wherein the guide mechanism comprises a motor and a shaft having outer threads operatively connected to the printing assembly for its movement.

6. The optical disc recorder of claim 5, wherein the shaft is driven through the printing assembly, further comprising a pin provided in the printing assembly, the pin being adapted to slidably dispose in the threads.

7. The optical disc recorder of claim 2, wherein the housing comprises a plurality of holes disposed corresponding to the ink cartridge.

8. The optical disc recorder of claim 1, further comprising a scanning module provided on an opening of the tray, the scanning module being adapted to scan contents printed on the label side of a loading optical disc.

9. An optical disc recorder comprising:
a housing;
an optical pick up module;
a tray;
a spindle motor mounted in a center of the tray; and
a printing device disposed between an inner surface of the housing and the tray and facing a label side of a loaded optical disc, the printing device comprising:
a thermal printing assembly;
a guide mechanism for guiding the thermal printing assembly to move alternately back and forth along a predetermined path above the label side; and
a control circuit for controlling the guide mechanism in cooperation with a movement of the thermal printing assembly for printing color text and/or graphics on the label side when the optical disc is rotating in a data recording operation.

10. The optical disc recorder of claim 9, wherein the thermal printing assembly includes a color ribbon module and a heating head.

11. The optical disc recorder of claim 9, wherein the spindle motor is adapted to intermittently or continuously angularly rotate the optical disc in cooperation with the movement of the thermal printing assembly.

12. The optical disc recorder of claim 9, further comprising a scanning module provided on an opening of the tray, the scanning module being adapted to scan contents printed on the label side of a loading optical disc.

13. The optical disc recorder of claim 9, wherein the guide mechanism comprises a motor and a shaft having outer threads operatively connected to the thermal printing assembly for its movement.

14. The optical disc recorder of claim 13, wherein the shaft is driven through the thermal printing assembly, further comprising a pin provided in the thermal printing assembly, the pin being adapted to slidably dispose in the threads.
